(19) United States
(12) Patent Application Publication
(10) Pub. No.: US 2026/0246569 A1
(43) Pub. Date: Aug. 20, 2026

(54) PHYSICAL RANDOM ACCESS CHANNEL RETRANSMISSION

(71) Applicant: QUALCOMM Incorporated, San Diego, CA (US)

(72) Inventors: Fang YUAN, Beijing (CN); Yan ZHOU, San Diego, CA (US)

(21) Appl. No.: 19/153,729

(22) PCT Filed: Apr. 3, 2023
(86) PCT No.: PCT/CN2023/085844

§ 371 Date: Aug. 5, 2025

(51) Int. Cl. H04L 1/18; H04W 74/0833

(52) U.S. Cl. CPC H04L 1/18; H04W 74/0833

(57) ABSTRACT

Various aspects of the present disclosure generally relate to wireless communication. In some aspects, a user equipment (UE) may receive a physical downlink control channel (PDCCH) order from a serving cell. The UE may transmit a physical random access channel (PRACH) transmission to a candidate cell. The UE may determine whether to retransmit the PRACH transmission when a random access response (RAR) transmission is not configured or indicated by the serving cell or the candidate cell. Numerous other aspects are described.

### FIELD OF THE DISCLOSURE

Aspects of the present disclosure generally relate to wireless communication and to techniques and apparatuses for retransmission of physical random access channel communications.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a physical downlink control channel (PDCCH) order from a serving cell. The method may include transmitting a physical random access channel (PRACH) transmission to a candidate cell. The method may include determining whether to retransmit the PRACH transmission when a random access response (RAR) transmission is not configured or indicated by the serving cell or the candidate cell.

Some aspects described herein relate to a method of wireless communication performed by a network node. The method may include transmitting a PDCCH order from a serving cell. The method may include configuring a UE to transmit a PRACH transmission to a candidate cell. The method may include configuring the UE to determine whether to retransmit the PRACH transmission when an RAR transmission is not configured or indicated by the serving cell or the candidate cell.

Some aspects described herein relate to a UE for wireless communication. The UE may include a memory and one or more processors coupled to the memory. The one or more processors may be configured to receive a PDCCH order from a serving cell. The one or more processors may be configured to transmit a PRACH transmission to a candidate cell. The one or more processors may be configured to determine whether to retransmit the PRACH transmission when an RAR transmission is not configured or indicated by the serving cell or the candidate cell.

Some aspects described herein relate to a network node for wireless communication. The network node may include a memory and one or more processors coupled to the memory. The one or more processors may be configured to transmit a PDCCH order from a serving cell. The one or more processors may be configured to configure a UE to transmit a PRACH transmission to a candidate cell. The one or more processors may be configured to configure the UE to determine whether to retransmit the PRACH transmission when an RAR transmission is not configured or indicated by the serving cell or the candidate cell.

Some aspects described herein relate to a non-transitory computer-readable medium that stores a set of instructions for wireless communication by a UE. The set of instructions, when executed by one or more processors of the UE, may cause the UE to receive a PDCCH order from a serving cell. The set of instructions, when executed by one or more processors of the UE, may cause the UE to transmit a PRACH transmission to a candidate cell. The set of instructions, when executed by one or more processors of the UE, may cause the UE to determine whether to retransmit the PRACH transmission when an RAR transmission is not configured or indicated by the serving cell or the candidate cell.

Some aspects described herein relate to a non-transitory computer-readable medium that stores a set of instructions for wireless communication by a network node. The set of instructions, when executed by one or more processors of the network node, may cause the network node to transmit a PDCCH order from a serving cell. The set of instructions, when executed by one or more processors of the network node, may cause the network node to configure a UE to transmit a PRACH transmission to a candidate cell. The set of instructions, when executed by one or more processors of the network node, may cause the network node to configure the UE to determine whether to retransmit the PRACH transmission when an RAR transmission is not configured or indicated by the serving cell or the candidate cell.

Some aspects described herein relate to an apparatus for wireless communication. The apparatus may include means for receiving a PDCCH order from a serving cell. The apparatus may include means for transmitting a PRACH transmission to a candidate cell. The apparatus may include means for determining whether to retransmit the PRACH transmission when an RAR transmission is not configured or indicated by the serving cell or the candidate cell.

Some aspects described herein relate to an apparatus for wireless communication. The apparatus may include means for transmitting a PDCCH order from a serving cell. The apparatus may include means for configuring a UE to transmit a PRACH transmission to a candidate cell. The apparatus may include means for configuring the UE to determine whether to retransmit the PRACH transmission when an RAR transmission is not configured or indicated by the serving cell or the candidate cell.

Aspects generally include a method, apparatus, system, computer program product, non-transitory computer-readable medium, UE, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of physical channels and reference signals in a wireless network, in accordance with the present disclosure.

FIG. 5 is a diagram illustrating an example of Layer 1/Layer 2 triggered mobility (LTM), in accordance with the present disclosure.

FIG. 6 is a diagram illustrating an example associated with retransmission of physical random access channel communications in LTM, in accordance with the present disclosure.

FIG. 7 is a diagram illustrating an example process performed, for example, by a UE, in accordance with the present disclosure.

FIG. 8 is a diagram illustrating an example process performed, for example, by a network node, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Layer 1 (L1)/Layer 2 (L2) triggered mobility (LTM) allows network devices, such as a user equipment (UE), to move seamlessly between network cells. In LTM, the handover between network cells may be initiated by the UE based on measurements taken by the UE's L1 radio interface and L2 radio access technology. When the UE detects a weak signal on one cell, the UE may initiate a handover to another cell with a stronger signal.

The UE may use the physical random access channel (PRACH) to initiate communications with a network cell. For example, the UE may transmit a PRACH preamble to the cell, and the network cell may respond to the UE by transmitting a physical downlink control channel (PDCCH) order containing information such as the time and frequency resources for a PRACH transmission. The network cell may respond to the PRACH transmission by transmitting a random access response (RAR). The RAR may include information, such as a timing advance (TA) identifier and a random access preamble identifier, among other examples, that the UE may use to communicate with the network cell via the PRACH.

While LTM supports PRACH transmissions, LTM does not support PRACH retransmissions (which are retransmissions of a previous PRACH transmission). Therefore, if a PRACH transmission is sent before the handover to a neighboring cell, but the RAR is not received by the UE, the UE cannot retransmit the PRACH transmission. Rather, the UE must initiate a new PRACH transmission.

Some techniques and apparatuses described herein enable the UE to receive a PDCCH order from a serving cell, transmit a PRACH transmission to a candidate cell, and determine whether to retransmit the PRACH transmission when an RAR transmission is not configured or indicated by the serving cell or the candidate cell. Accordingly, the UE can retransmit the PRACH transmission without having to initiate a new PRACH transmission, which may reduce network overhead and increase network efficiency.

Some techniques and apparatuses described herein enable a network node to transmit a PDCCH order from a serving cell, configure a UE to transmit a PRACH transmission to a candidate cell, and configure the UE to determine whether to retransmit the PRACH transmission when an RAR transmission is not configured or indicated by the serving cell or the candidate cell. By configuring the UE to determine whether to initiate the PRACH retransmission, the network node may improve network efficiency by reducing the number of new PRACH transmissions in LTM.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

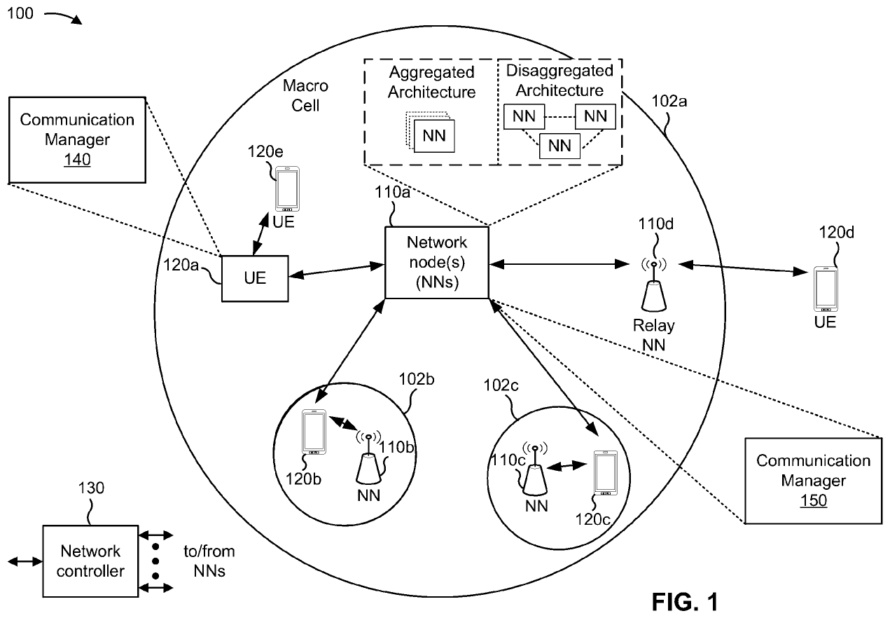

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a PDCCH order from a serving cell; transmit a PRACH transmission to a candidate cell; and determine whether to retransmit the PRACH transmission when an RAR transmission is not configured or indicated by the serving cell or the candidate cell. Additionally, or alternatively, the communication manager 140 may perform one or more other operations described herein.

In some aspects, the network node 110 may include a communication manager 150. As described in more detail elsewhere herein, the communication manager 150 may transmit a PDCCH order from a serving cell; configure a UE 120 to transmit a PRACH transmission to a candidate cell; and configure the UE 120 to determine whether to retransmit the PRACH transmission when an RAR transmission is not configured or indicated by the serving cell or the candidate cell. Additionally, or alternatively, the communication manager 150 may perform one or more other operations described herein.

As indicated above, FIG. 1 is provided as an example. Other examples may differ from what is described with regard to FIG. 1.

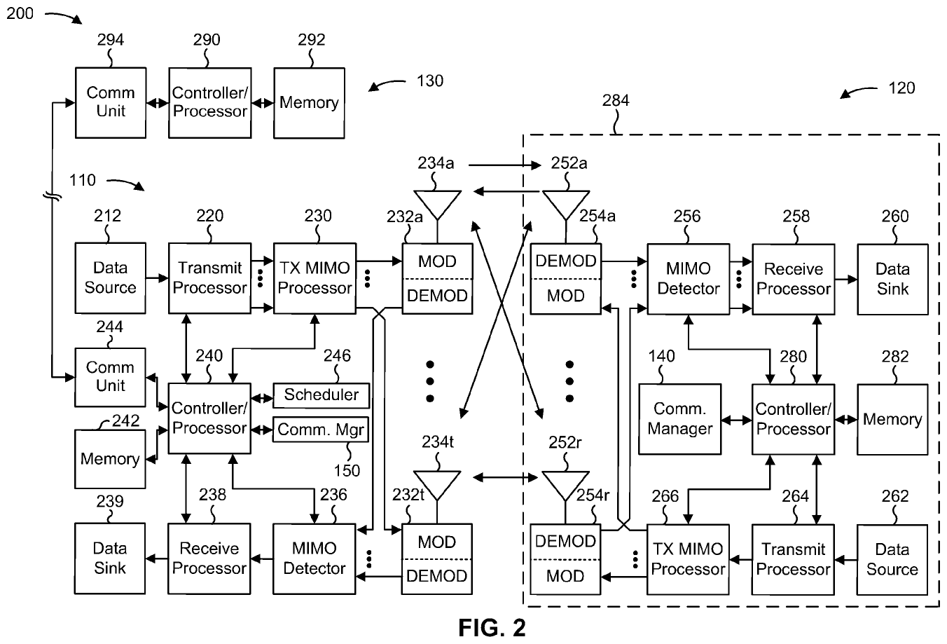

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

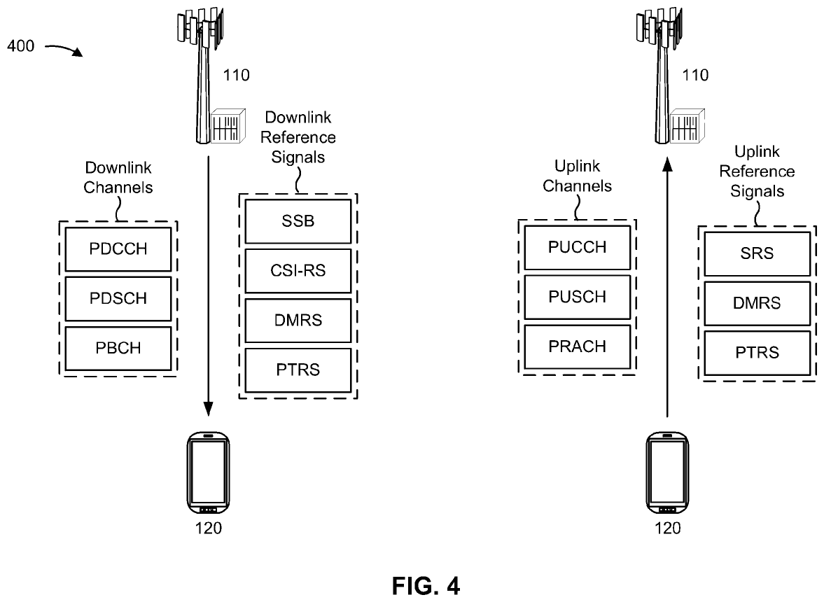

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-10).

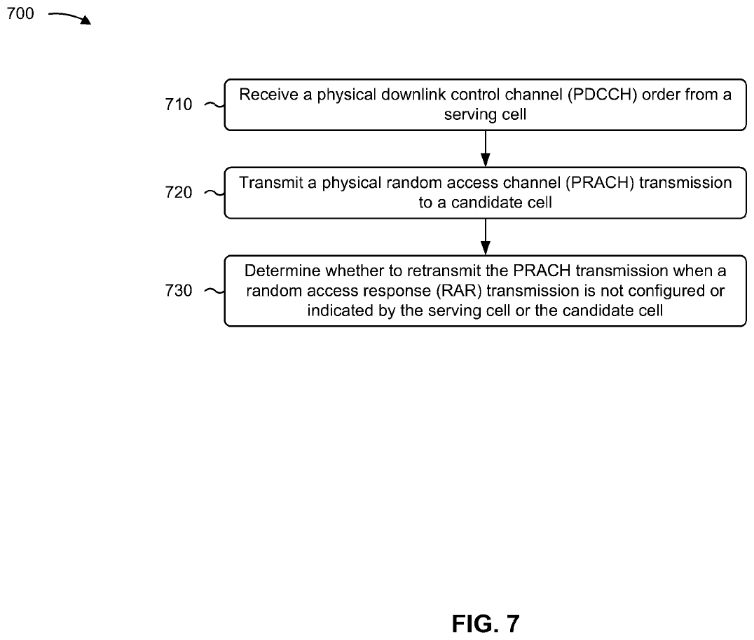

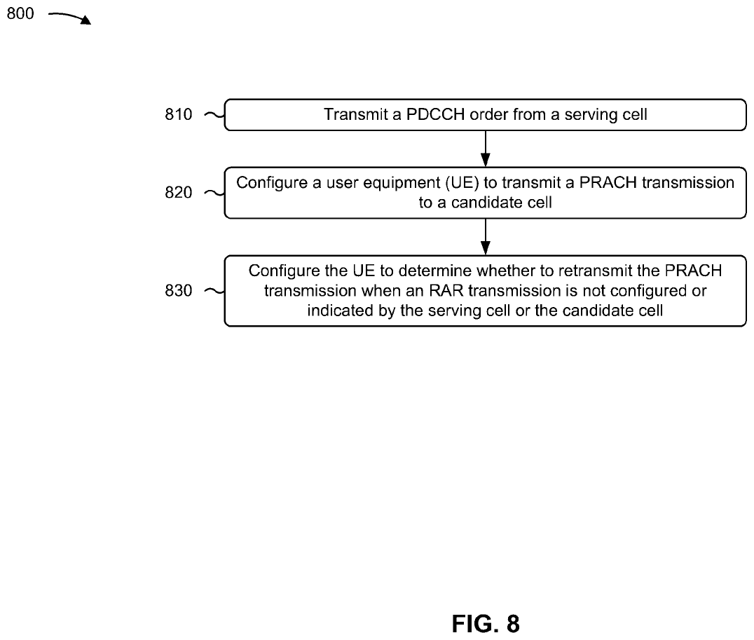

The controller/processor 240 of the network node 110, the controller/processor 280 of the UE 120, and/or any other component(s) of FIG. 2 may perform one or more techniques associated with PRACH retransmissions in LTM, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the UE 120 includes means for receiving a PDCCH order from a serving cell; means for transmitting a PRACH transmission to a candidate cell; and/or means for determining whether to retransmit the PRACH transmission when an RAR transmission is not configured or indicated by the serving cell or the candidate cell. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting a PDCCH order from a serving cell; means for configuring a UE 120 to transmit a PRACH transmission to a candidate cell; and/or means for configuring the UE 120 to determine whether to retransmit the PRACH transmission when an RAR transmission is not configured or indicated by the serving cell or the candidate cell. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

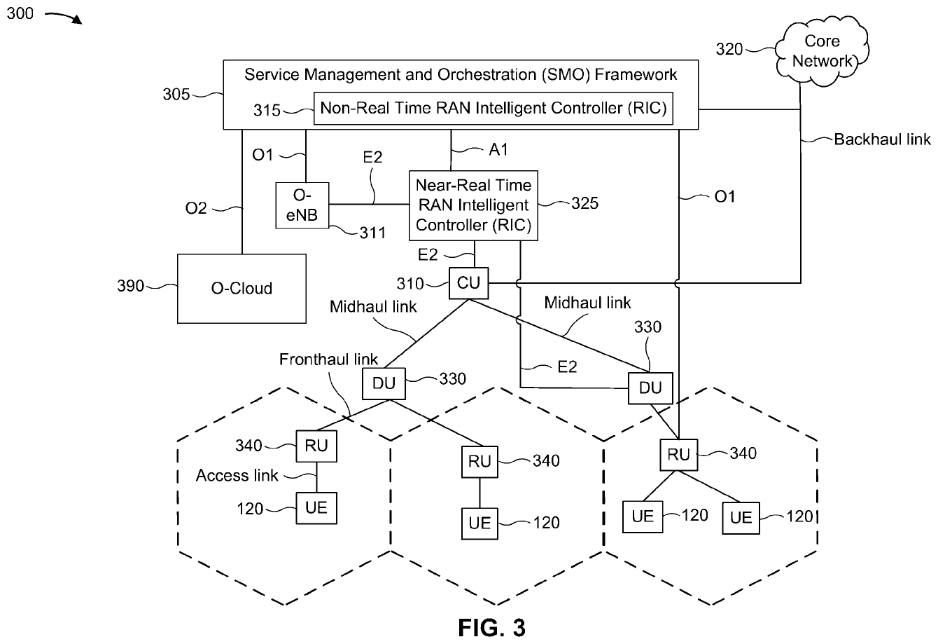

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or PRACH extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an Ol interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating an example 400 of physical channels and reference signals in a wireless network, in accordance with the present disclosure. As shown in FIG. 4, downlink channels and downlink reference signals may carry information from a network node 110 to a UE 120, and uplink channels and uplink reference signals may carry information from a UE 120 to a network node 110.

As shown, a downlink channel may include a PDCCH that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a PRACH used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (CSI-RS), a DMRS, a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a channel quality indicator (CQI), a precoding matrix indicator (PMI), a CSI-RS resource indicator (CRI), a layer indicator (LI), a rank indicator (RI), or a reference signal received power (RSRP), among other examples. The network node 110 may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

As indicated above, FIG. 4 is provided as an example. Other examples may differ from what is described with regard to FIG. 4.

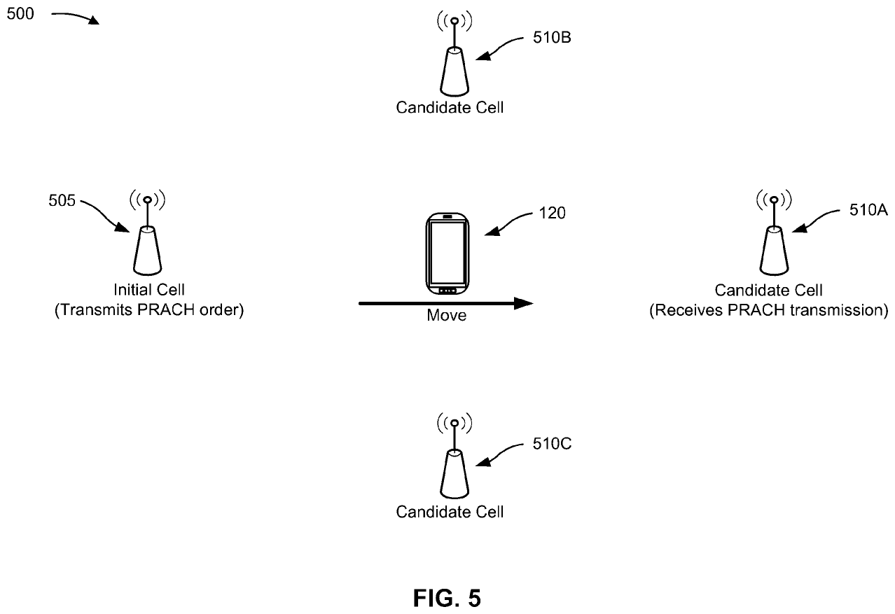

FIG. 5 is a diagram illustrating an example 500 of LTM, in accordance with the present disclosure. LTM allows the UE to maintain communication with the network while moving between network cells, such as between an initial cell 505 and one or more candidate cells 510A-510C. The initial cell 505 may include a network cell with which the UE 120 had been communicating and which had transmitted a PDCCH order to the UE 120. The candidate cells 510A-510C may include neighboring cells relative to the initial cell 505. In some instances, one or more of the candidate cells 510A-510C may have a stronger signal than the initial cell 505. The change in signal strength between the UE 120 and the initial cell 505 may be the result of the UE moving away from the initial cell 505.

In LTM, the handover from the initial cell 505 to one of the candidate cells 510A-510C may be initiated by the UE 120 based on measurements taken by the radio interface (L1) and radio access technology (L2) of the UE 120. When the UE 120 detects a weak signal on the initial cell 505, the UE 120 may initiate a handover to one of the candidate cells 510A-510C with a stronger signal. The initial cell 505 may be referred to as a serving cell, and the initial cell 505 and candidate cells 510A-510C may be special cells (SpCells).

As shown in the example 500, the UE 120 is moving toward the candidate cell 510A. If the measurements indicate that the candidate cell 510A has the strongest signal, the UE 120 may initiate the handover from the initial cell 505 to the candidate cell 510A.

Prior to the handover to the candidate cell 510A, the initial cell 505 may have transmitted a PDCCH order to the UE 120. After the handover, the UE 120 may have transmitted a PRACH transmission to the candidate cell 510A. Accordingly, the UE 120 may have transmitted the PRACH transmission to a cell (i.e., the candidate cell 510A) that is different from the cell that transmitted the PDCCH order (i.e., the initial cell 505), resulting in an ambiguity where the UE 120 does not know whether the RAR will be transmitted from the initial cell 505 or the candidate cell 510A. Moreover, without additional configurations, the UE 120 may be unable to retransmit the PRACH transmission without a new PDCCH order. Therefore, the UE 120 may need to initiate a new PRACH transmission.

Some techniques and apparatuses described herein enable the UE to receive a PDCCH order from a serving cell, transmit a PRACH transmission to a candidate cell, and determine whether to retransmit the PRACH transmission when an RAR transmission is not configured or indicated by the serving cell or the candidate cell. Accordingly, the UE can retransmit the PRACH transmission without having to initiate a new PRACH transmission, which may reduce network overhead and increase network efficiency.

Some techniques and apparatuses described herein enable a network node to transmit a PDCCH order from a serving cell, configure a UE to transmit a PRACH transmission to a candidate cell, and configure the UE to determine whether to retransmit the PRACH transmission when an RAR transmission is not configured or indicated by the serving cell or the candidate cell. By configuring the UE to determine whether to initiate the PRACH retransmission, the network node may improve network efficiency by reducing the number of new PRACH transmissions in LTM.

As indicated above, FIG. 5 is provided as an example. Other examples may differ from what is described with respect to FIG. 5.

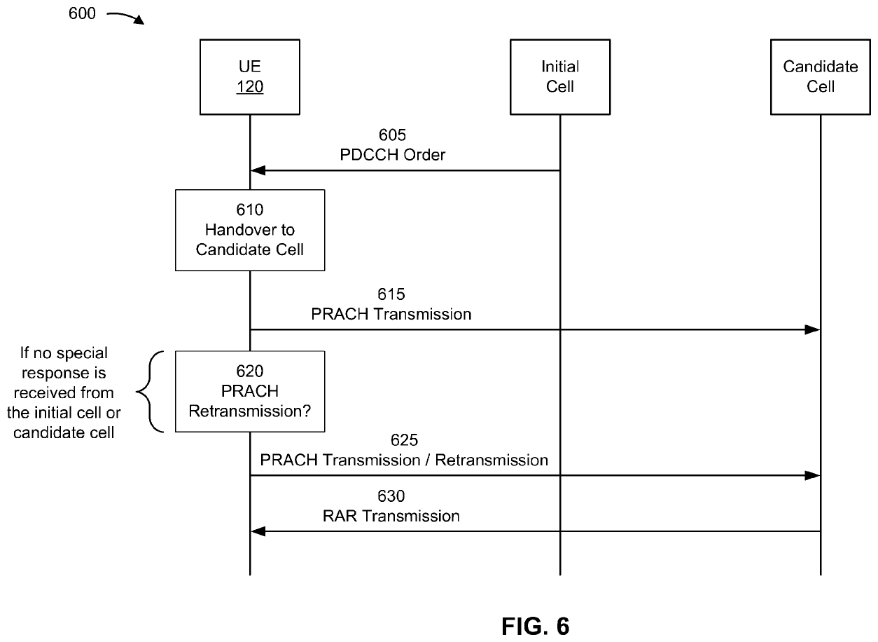

FIG. 6 is a diagram illustrating an example 600 associated with retransmission of PRACH transmissions in LTM, in accordance with the present disclosure. As shown in FIG. 6, a UE (such as UE 120) may communicate with an initial cell (such as initial cell 505) and a candidate cell (such as candidate cell 510A). In some instances, the initial cell (sometimes called a “serving cell”) and candidate cell are each part of a different network node 110. In some instances, the network node 110 may include multiple serving cells, and one or more serving cells of the network node 110 may act as the initial cell or the candidate cell, among other examples.

As shown by reference number 605, the initial cell may transmit, and the UE may receive, a PDCCH order. The PDCCH order may contain information, such as the time and frequency resources, for PRACH transmission between the UE and the initial cell or candidate cell.

As shown by reference number 610, the UE may transition to communication via the candidate cell. In some aspects, the UE may perform an LTM handover process to communicate via the candidate cell. The LTM handover process may include measuring signals transmitted from multiple candidate cells and transitioning to the candidate cell with the highest signal strength.

As shown by reference number 615, the UE may transmit, and the candidate cell may receive, the PRACH transmission. The PRACH transmission may be communicated from the UE to the candidate cell in accordance with the PDCCH order transmitted from the initial cell and received at the UE.

As shown by reference number 620, the UE may determine whether to retransmit the PRACH transmission. In some instances, the UE may further determine how many PRACH retransmissions are permissible. The UE may determine to retransmit the PRACH transmission in instances when an RAR transmission is not configured or indicated by the initial cell or the candidate cell. In some aspects, the UE may be configured to determine a number of PRACH retransmissions to attempt in response to the PDCCH order. In some aspects, the UE may receive RRC signaling, transmitted by the initial cell or the candidate cell, indicating whether PRACH retransmissions are permitted or not with respect to the PDCCH order. The UE may be configured to only perform a retransmission for a PRACH when the UE is configured to do so by RRC signaling. In some aspects, the UE may receive RRC signaling, transmitted by the initial cell or the candidate cell, indicating the number of PRACH retransmissions that are permitted with respect to the PDCCH order. The UE may be configured to perform a number of a PRACH retransmissions for a trigged PRACH transmission based on the RRC signaling. In some aspects, RRC signaling may indicate a maximum number of PRACH retransmissions permitted. The UE may be configured to perform an unlimited number of a PRACH retransmissions for a trigged PRACH transmission if not receiving the RRC signaling. In some aspects, RRC signaling may indicate a power associated with PRACH retransmissions. The power associated with the PRACH retransmissions may be cumulative when RACH retransmissions are performed. For example, the power for a PRACH retransmission may accumulate relative to the power associated with an earlier corresponding PRACH retransmission or transmission occasion (e.g., increase the power by X dB for each subsequent PRACH retransmission). Alternatively, the accumulated power may be based on how many previous PRACH retransmission occasions have already occurred (e.g., the power of the first PRACH retransmission may be X dB greater than the power of the initial PRACH transmission, the power of the second PRACH retransmission may be 2×X dB greater than the power of the initial PRACH transmission, etc.). The value of X may be configured by RRC signaling or may be a predetermined fixed value.

In some aspects, the UE may receive DCI signaling indicating whether a PRACH retransmission is permitted. For instance, the DCI signaling may include a bit indicating whether one or more PRACH retransmissions are permitted, where the DCI may trigger the PRACH transmission. In some aspects, the DCI signaling may include a bit with a first value indicating that the UE should transmit a new PRACH transmission rather than attempt to retransmit a PRACH transmission. In some aspects, the DCI signaling may include a bit with a second value indicating that the UE should retransmit a PRACH transmission rather than attempt to transmit a new PRACH transmission. In some aspects, toggling the bit in the DCI may provide the indication of whether the UE may retransmit the PRACH transmission. In some aspects, the DCI signaling may include a toggled bit indicating that the UE should transmit a new PRACH transmission rather than attempt to retransmit a PRACH transmission. In some aspects, the DCI signaling may include a non-toggled bit with a second value indicating that the UE should retransmit a PRACH transmission rather than attempt to transmit a new PRACH transmission. In some aspects, the DCI signaling includes a multi-bit field indicating the number of allowable PRACH retransmissions. In some aspects, the multi-bit field may indicate a retransmission number associated with the PRACH retransmission (e.g., the multi-bit field may indicate that the triggered PRACH retransmission is the nth retransmission of the PRACH transmission). In some aspects, a bit length of the multi-bit field may be based on the maximum number of allowable PRACH transmissions. For example, a 2-bit field may indicate a maximum of 4 PRACH retransmissions or a 3-bit field may indicate a maximum of 8 PRACH retransmissions, among other examples.

In some aspects, the UE may receive DCI signaling or RRC signaling indicating a power boosting value indicating a number of power boosting steps for one or more of the PRACH retransmissions. In some aspects, the number of allowable PRACH retransmissions may be based, at least in part, on the power boosting value. For example, the power boost may be aggregated relative to the power boost associated with an earlier PRACH retransmission occasion (e.g., increase the power boost by 3 dB for each subsequent PRACH retransmission). Alternatively, the power boost may be based on how many previous PRACH retransmission occasions have already occurred (e.g., the power boost of the initial PRACH transmission may be 0 dB, the power boost of the first PRACH retransmission may be 3 dB greater than the power boost of the initial PRACH transmission, the power boost of the second PRACH retransmission may be 6 dB greater than the power boost of the initial PRACH transmission, etc.).

As shown by reference number 625, the UE may retransmit the PRACH transmission (or transmit a new PRACH transmission) to the candidate cell according to the number of retransmissions permitted by the PDCCH order and the determinations discussed above with respect to reference number 620. In some aspects, the UE may periodically retransmit the PRACH transmission until a special response is received from the candidate cell or the initial cell or until a maximum number of PRACH retransmission occasions has occurred. The special response may include a transmission from the candidate cell acknowledging the PRACH transmission. In some aspects, the PRACH retransmissions may occur until, for example, the special response such as DCI signaling or MAC control element (MAC-CE) signaling is received from the initial cell or the candidate cell. For example, the UE may stop retransmitting the PRACH as a result of receiving DCI signaling that triggers a contention-based random access PRACH in the candidate cell.

As shown by reference number 630, the candidate cell may transmit, and the UE may receive, the special response transmission. The special response transmission may confirm that the PRACH transmission was received, that the UE may use to communicate with the candidate cell 510A via the PRACH. In some aspects, the special response transmission may be received via DCI signaling or MAC-CE signaling from one of the initial cell or the candidate cell.

Accordingly, with the example 600, the UE may be configured to retransmit PRACH transmissions to the candidate cell following an LTM process without initiating a new PRACH transmission. The example 600 may reduce network overhead and increase network efficiency by reducing the number of new PRACH transmissions during LTM.

As indicated above, FIG. 6 is provided as an example. Other examples may differ from what is described with respect to FIG. 6.

FIG. 7 is a diagram illustrating an example process 700 performed, for example, by a UE, in accordance with the present disclosure. Example process 700 is an example where the UE (e.g., UE 120) performs operations associated with PRACH retransmissions in LTM.

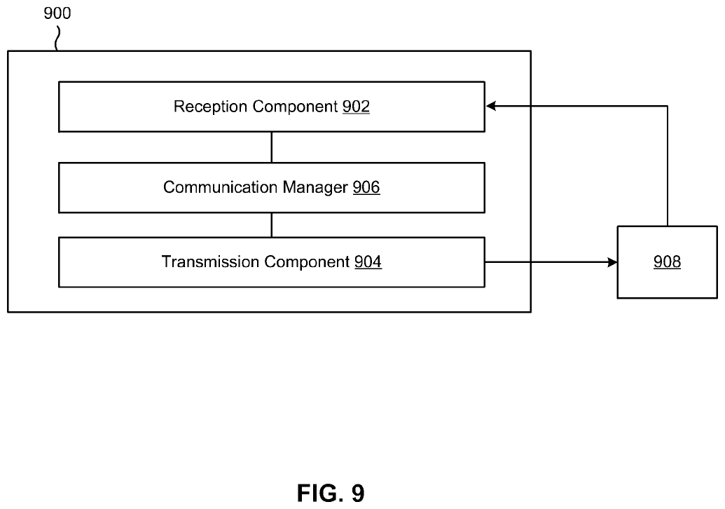

As shown in FIG. 7, in some aspects, process 700 may include receiving a PDCCH order from a serving cell (block 710). For example, the UE (e.g., using reception component 902 and/or communication manager 906, depicted in FIG. 9) may receive a PDCCH order from a serving cell, as described above.

As further shown in FIG. 7, in some aspects, process 700 may include transmitting a PRACH transmission to a candidate cell (block 720). For example, the UE (e.g., using transmission component 904 and/or communication manager 906, depicted in FIG. 9) may transmit a PRACH transmission to a candidate cell, as described above.

As further shown in FIG. 7, in some aspects, process 700 may include determining whether to retransmit the PRACH transmission when an RAR transmission is not configured or indicated by the serving cell or the candidate cell (block 730). For example, the UE (e.g., using communication manager 906, depicted in FIG. 9) may determine whether to retransmit the PRACH transmission when an RAR transmission is not configured or indicated by the serving cell or the candidate cell, as described above.

Process 700 may include additional aspects, such as any single aspect or any combination of aspects described below and/or in connection with one or more other processes described elsewhere herein.

In a first aspect, determining whether to retransmit the PRACH transmission includes determining a number of PRACH retransmissions to attempt in response to the PDCCH order.

In a second aspect, alone or in combination with the first aspect, determining whether to retransmit the PRACH transmission includes receiving RRC signaling indicating whether a PRACH retransmission is permitted.

In a third aspect, alone or in combination with one or more of the first and second aspects, process 700 includes retransmitting the PRACH transmission as a result of the RRC signaling indicating that the PRACH retransmission is permitted.

In a fourth aspect, alone or in combination with one or more of the first through third aspects, determining whether to retransmit the PRACH transmission includes receiving DCI signaling indicating whether a PRACH retransmission is permitted.

In a fifth aspect, alone or in combination with one or more of the first through fourth aspects, process 700 includes retransmitting the PRACH transmission based, at least in part, on a bit in the DCI signaling.

In a sixth aspect, alone or in combination with one or more of the first through fifth aspects, process 700 includes transmitting a new PRACH transmission based, at least in part, on a bit in the DCI signaling.

In a seventh aspect, alone or in combination with one or more of the first through sixth aspects, a maximum number of PRACH retransmissions is based, at least in part, on radio resource control signaling.

In an eighth aspect, alone or in combination with one or more of the first through seventh aspects, a power associated with the PRACH retransmission is based, at least in part, on radio resource control signaling.

In a ninth aspect, alone or in combination with one or more of the first through eighth aspects, a power associated with the PRACH retransmission accumulates relative to an earlier PRACH retransmission occasion.

In a tenth aspect, alone or in combination with one or more of the first through ninth aspects, the DCI signaling includes a multi-bit field indicating a number of allowable PRACH retransmissions.

In an eleventh aspect, alone or in combination with one or more of the first through tenth aspects, the DCI signaling includes a multi-bit field indicating a retransmission number associated with a most recent PRACH retransmission.

In a twelfth aspect, alone or in combination with one or more of the first through eleventh aspects, the DCI signaling includes a multi-bit field, wherein a bit length of the multi-bit field indicates a maximum number of allowable PRACH retransmissions.

In a thirteenth aspect, alone or in combination with one or more of the first through twelfth aspects, process 700 includes receiving a power boosting value indicating a number of power boosting steps for one or more PRACH retransmissions.

In a fourteenth aspect, alone or in combination with one or more of the first through thirteenth aspects, the power boosting value is received via downlink control information signaling.

In a fifteenth aspect, alone or in combination with one or more of the first through fourteenth aspects, the power boosting value is received via radio resource control signaling.

In a sixteenth aspect, alone or in combination with one or more of the first through fifteenth aspects, process 700 includes determining a PRACH retransmission power based, at least in part, on a power boosting value associated with a number of PRACH retransmission occasions.

In a seventeenth aspect, alone or in combination with one or more of the first through sixteenth aspects, determining the PRACH retransmission power includes aggregating two or more power boosting values from previous PRACH retransmission occasions.

In an eighteenth aspect, alone or in combination with one or more of the first through seventeenth aspects, process 700 includes retransmitting the PRACH transmission until a special response transmission is received from one or more of the serving cell or the candidate cell.

In a nineteenth aspect, alone or in combination with one or more of the first through eighteenth aspects, process 700 includes receiving a special response transmission.

In a twentieth aspect, alone or in combination with one or more of the first through nineteenth aspects, a special response transmission is received via DCI signaling or MAC-CE signaling from one of the serving cell or the candidate cell.

In a twenty-first aspect, alone or in combination with one or more of the first through twentieth aspects, process 700 includes triggering a contention-based random access PRACH transmission in response to receiving the DCI signaling.

In a twenty-second aspect, alone or in combination with one or more of the first through twenty-first aspects, process 700 includes retransmitting the PRACH transmission until a maximum number of PRACH retransmission occasions has occurred.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network node, in accordance with the present disclosure. Example process 800 is an example where the network node (e.g., network node 110) performs operations associated with PRACH retransmissions in LTM.

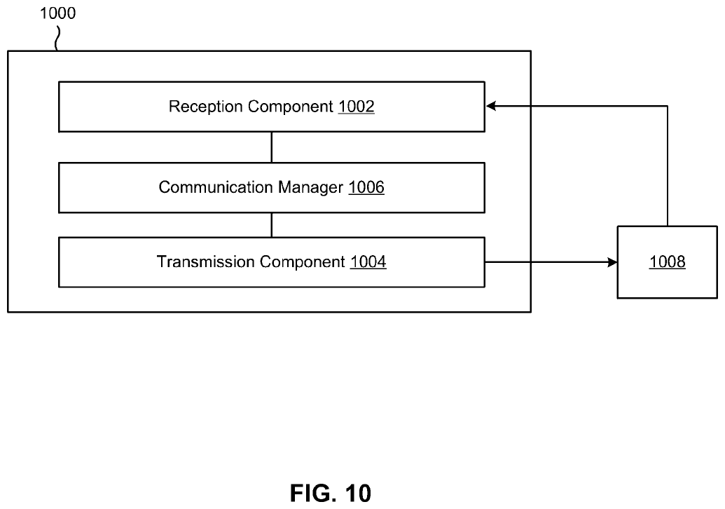

As shown in FIG. 8, in some aspects, process 800 may include transmitting a PDCCH order from a serving cell (block 810). For example, the network node (e.g., using transmission component 1004 and/or communication manager 1006, depicted in FIG. 10) may transmit a PDCCH order from a serving cell, as described above.

As further shown in FIG. 8, in some aspects, process 800 may include configuring a UE to transmit a PRACH transmission to a candidate cell (block 820). For example, the network node (e.g., using communication manager 1006, depicted in FIG. 10) may configure a UE to transmit a PRACH transmission to a candidate cell, as described above.

As further shown in FIG. 8, in some aspects, process 800 may include configuring the UE to determine whether to retransmit the PRACH transmission when an RAR transmission is not configured or indicated by the serving cell or the candidate cell (block 830). For example, the network node (e.g., using communication manager 1006, depicted in FIG. 10) may configure the UE to determine whether to retransmit the PRACH transmission when an RAR transmission is not configured or indicated by the serving cell or the candidate cell, as described above.

Process 800 may include additional aspects, such as any single aspect or any combination of aspects described below and/or in connection with one or more other processes described elsewhere herein.

In a first aspect, configuring the UE to determine whether to retransmit the PRACH transmission includes determining a number of PRACH retransmissions to attempt in response to the PDCCH order.

In a second aspect, alone or in combination with the first aspect, configuring the UE to determine whether to retransmit the PRACH transmission includes outputting RRC signaling indicating whether a PRACH retransmission is permitted.

In a third aspect, alone or in combination with one or more of the first and second aspects, process 800 includes configuring the UE to retransmit the PRACH transmission in response to the RRC signaling indicating that the PRACH retransmission is permitted.

In a fourth aspect, alone or in combination with one or more of the first through third aspects, configuring the UE to determine whether to retransmit the PRACH transmission includes outputting DCI signaling indicating whether a PRACH retransmission is permitted.

In a fifth aspect, alone or in combination with one or more of the first through fourth aspects, process 800 includes configuring the UE to retransmit the PRACH transmission based, at least in part, on a bit in the DCI signaling.

In a sixth aspect, alone or in combination with one or more of the first through fifth aspects, process 800 includes configuring the UE to transmit a new PRACH transmission based, at least in part, on a bit in the DCI signaling.

In a seventh aspect, alone or in combination with one or more of the first through sixth aspects, a maximum number of PRACH retransmissions is based, at least in part, on radio resource control signaling.

In an eighth aspect, alone or in combination with one or more of the first through seventh aspects, a power associated with the PRACH retransmission is based, at least in part, on radio resource control signaling.

In a ninth aspect, alone or in combination with one or more of the first through eighth aspects, a power associated with the PRACH retransmission accumulates relative to an earlier PRACH retransmission occasion.

In a tenth aspect, alone or in combination with one or more of the first through ninth aspects, the DCI signaling includes a multi-bit field indicating a number of allowable PRACH retransmissions.

In an eleventh aspect, alone or in combination with one or more of the first through tenth aspects, the DCI signaling includes a multi-bit field indicating a retransmission number associated with a most recent PRACH retransmission.

In a twelfth aspect, alone or in combination with one or more of the first through eleventh aspects, the DCI signaling includes a multi-bit field, wherein a bit length of the multi-bit field indicates a maximum number of allowable PRACH retransmissions.

In a thirteenth aspect, alone or in combination with one or more of the first through twelfth aspects, process 800 includes outputting a power boosting value indicating a number of power boosting steps for one or more PRACH retransmissions.

In a fourteenth aspect, alone or in combination with one or more of the first through thirteenth aspects, the power boosting value is output to the UE via downlink control information signaling.

In a fifteenth aspect, alone or in combination with one or more of the first through fourteenth aspects, the power boosting value is output to the UE via radio resource control signaling.

In a sixteenth aspect, alone or in combination with one or more of the first through fifteenth aspects, process 800 includes configuring the UE to determine a PRACH retransmission power based, at least in part, on a power boosting value associated with a number of PRACH retransmission occasions.

In a seventeenth aspect, alone or in combination with one or more of the first through sixteenth aspects, configuring the UE to determine the PRACH retransmission power includes aggregating two or more power boosting values from previous PRACH retransmission occasions.

In an eighteenth aspect, alone or in combination with one or more of the first through seventeenth aspects, process 800 includes configuring the UE to retransmit the PRACH transmission until a special response is received from one or more of the serving cell or the candidate cell.

In a nineteenth aspect, alone or in combination with one or more of the first through eighteenth aspects, process 800 includes outputting the special response transmission.

In a twentieth aspect, alone or in combination with one or more of the first through nineteenth aspects, the special response transmission is output to the UE via DCI signaling or MAC-CE signaling.

In a twenty-first aspect, alone or in combination with one or more of the first through twentieth aspects, process 800 includes configuring the UE to perform a contention-based random access PRACH transmission in response to the UE receiving the DCI signaling.

In a twenty-second aspect, alone or in combination with one or more of the first through twenty-first aspects, process 800 includes configuring the UE to retransmit the PRACH transmission until a maximum number of PRACH retransmission occasions has occurred.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 4-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive a PDCCH order from a serving cell. The transmission component 904 may transmit a PRACH transmission to a candidate cell. The communication manager 906 may determine whether to retransmit the PRACH transmission when an RAR transmission is not configured or indicated by the serving cell or the candidate cell. The reception component 902 may receive a power boosting value indicating a number of power boosting steps for one or more PRACH retransmissions. The reception component 902 may receive the special response transmission.

The transmission component 904 may retransmit the PRACH transmission as a result of the RRC signaling indicating that the PRACH retransmission is permitted. The transmission component 904 may retransmit the PRACH transmission based, at least in part, on a bit in the DCI signaling. The transmission component 904 may transmit a new PRACH transmission based, at least in part, on a bit in the DCI signaling. The transmission component 904 may retransmit the PRACH transmission until the special response transmission is received from one or more of the serving cell or the candidate cell. The transmission component 904 may retransmit the PRACH transmission until a maximum number of PRACH retransmission occasions has occurred.

The communication manager 906 may determine a PRACH retransmission power based, at least in part, on a power boosting value associated with a number of PRACH retransmission occasions. The communication manager 906 may trigger a contention-based random access PRACH transmission in response to receiving the DCI signaling.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 4-6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network node described in connection with FIG. 2. In some aspects, the reception component 1002 and/or the transmission component 1004 may include or may be included in a network interface. The network interface may be configured to obtain and/or output signals for the apparatus 1000 via one or more communications links, such as a backhaul link, a midhaul link, and/or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the network node described in connection with FIG. 2. In some aspects, the transmission component 1004 may be co-located with the reception component 1002 in a transceiver.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The transmission component 1004 may transmit a PDCCH order from a serving cell. The communication manager 1006 may configure a UE to transmit a PRACH transmission to a candidate cell. The communication manager 1006 may configure the UE to determine whether to retransmit the PRACH transmission when an RAR transmission is not configured or indicated by the serving cell or the candidate cell. The transmission component 1004 may output a power boosting value indicating a number of power boosting steps for one or more PRACH retransmissions. The transmission component 1004 may output the special response transmission.

The communication manager 1006 may configure the UE to retransmit the PRACH transmission in response to the RRC signaling indicating that the PRACH retransmission is permitted. The communication manager 1006 may configure the UE to retransmit the PRACH transmission based, at least in part, on a bit in the DCI signaling. The communication manager 1006 may configure the UE to transmit a new PRACH transmission based, at least in part, on a bit in the DCI signaling. The communication manager 1006 may configure the UE to determine a PRACH retransmission power based, at least in part, on a power boosting value associated with a number of PRACH retransmission occasions. The communication manager 1006 may configure the UE to retransmit the PRACH transmission until a special response is received from one or more of the serving cell or the candidate cell. The communication manager 1006 may configure the UE to perform a contention-based random access PRACH transmission in response to the UE receiving the DCI signaling. The communication manager 1006 may configure the UE to retransmit the PRACH transmission until a maximum number of PRACH retransmission occasions has occurred.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:
Aspect 1: A method of wireless communication performed by a UE, comprising: receiving a PDCCH order from a serving cell; transmitting a PRACH transmission to a candidate cell; and determining whether to retransmit the PRACH transmission when an RAR transmission is not configured or indicated by the serving cell or the candidate cell.
Aspect 2: The method of Aspect 1, wherein determining whether to retransmit the PRACH transmission includes determining a number of PRACH retransmissions to attempt in response to the PDCCH order.
Aspect 3: The method of any of Aspects 1-2, wherein determining whether to retransmit the PRACH transmission includes receiving RRC signaling indicating whether a PRACH retransmission is permitted.
Aspect 4: The method of Aspect 3, further comprising retransmitting the PRACH transmission as a result of the RRC signaling indicating that the PRACH retransmission is permitted.
Aspect 5: The method of any of Aspects 1-4, wherein determining whether to retransmit the PRACH transmission includes receiving DCI signaling indicating whether a PRACH retransmission is permitted.
Aspect 6: The method of Aspect 5, further comprising retransmitting the PRACH transmission based, at least in part, on a bit in the DCI signaling.
Aspect 7: The method of Aspect 5, further comprising transmitting a new PRACH transmission based, at least in part, on a bit in the DCI signaling.
Aspect 8: The method of Aspect 5, wherein a maximum number of PRACH retransmissions is based, at least in part, on radio resource control signaling.
Aspect 9: The method of Aspect 5, wherein a power associated with the PRACH retransmission is based, at least in part, on radio resource control signaling.
Aspect 10: The method of Aspect 5, wherein a power associated with the PRACH retransmission accumulates relative to an earlier PRACH retransmission occasion.
Aspect 11: The method of Aspect 5, wherein the DCI signaling includes a multi-bit field indicating a number of allowable PRACH retransmissions.
Aspect 12: The method of Aspect 5, wherein the DCI signaling includes a multi-bit field indicating a retransmission number associated with a most recent PRACH retransmission.
Aspect 13: The method of Aspect 5, wherein the DCI signaling includes a multi-bit field, wherein a bit length of the multi-bit field indicates a maximum number of allowable PRACH retransmissions.
Aspect 14: The method of any of Aspects 1-13, further comprising receiving a power boosting value indicating a number of power boosting steps for one or more PRACH retransmissions.
Aspect 15: The method of Aspect 14, wherein the power boosting value is received via downlink control information signaling.
Aspect 16: The method of Aspect 14, wherein the power boosting value is received via radio resource control signaling.
Aspect 17: The method of any of Aspects 1-16, further comprising determining a PRACH retransmission power based, at least in part, on a power boosting value associated with a number of PRACH retransmission occasions.
Aspect 18: The method of Aspect 17, wherein determining the PRACH retransmission power includes aggregating two or more power boosting values from previous PRACH retransmission occasions.
Aspect 19: The method of any of Aspects 1-18, further comprising retransmitting the PRACH transmission until a special response transmission is received from one or more of the serving cell or the candidate cell.
Aspect 20: The method of Aspect 19, further comprising receiving the special response transmission.
Aspect 21: The method of Aspect 20, wherein the special response transmission is received via DCI signaling or MAC-CE signaling from one of the serving cell or the candidate cell.
Aspect 22: The method of Aspect 21, further comprising triggering a contention-based random access PRACH transmission in response to receiving the DCI signaling.
Aspect 23: The method of any of Aspects 1-22, further comprising retransmitting the PRACH transmission until a maximum number of PRACH retransmission occasions has occurred.
Aspect 24: A method of wireless communication performed by a network node, comprising: transmitting a PDCCH order from a serving cell; configuring a UE to transmit a PRACH transmission to a candidate cell; and configuring the UE to determine whether to retransmit the PRACH transmission when an RAR transmission is not configured or indicated by the serving cell or the candidate cell.
Aspect 25: The method of Aspect 24, wherein configuring the UE to determine whether to retransmit the PRACH transmission includes determining a number of PRACH retransmissions to attempt in response to the PDCCH order.
Aspect 26: The method of any of Aspects 24-25, wherein configuring the UE to determine whether to retransmit the PRACH transmission includes outputting RRC signaling indicating whether a PRACH retransmission is permitted.
Aspect 27: The method of Aspect 26, further comprising configuring the UE to retransmit the PRACH transmission in response to the RRC signaling indicating that the PRACH retransmission is permitted.
Aspect 28: The method of any of Aspects 24-27, wherein configuring the UE to determine whether to retransmit the PRACH transmission includes outputting DCI signaling indicating whether a PRACH retransmission is permitted.
Aspect 29: The method of Aspect 28, further comprising configuring the UE to retransmit the PRACH transmission based, at least in part, on a bit in the DCI signaling.
Aspect 30: The method of Aspect 28, further comprising configuring the UE to transmit a new PRACH transmission based, at least in part, on a bit in the DCI signaling.
Aspect 31: The method of Aspect 28, wherein a maximum number of PRACH retransmissions is based, at least in part, on radio resource control signaling.
Aspect 32: The method of Aspect 28, wherein a power associated with the PRACH retransmission is based, at least in part, on radio resource control signaling.
Aspect 33: The method of Aspect 28, wherein a power associated with the PRACH retransmission accumulates relative to an earlier PRACH retransmission occasion.
Aspect 34: The method of Aspect 28, wherein the DCI signaling includes a multi-bit field indicating a number of allowable PRACH retransmissions.
Aspect 35: The method of Aspect 28, wherein the DCI signaling includes a multi-bit field indicating a retransmission number associated with a most recent PRACH retransmission.
Aspect 36: The method of Aspect 28, wherein the DCI signaling includes a multi-bit field, wherein a bit length of the multi-bit field indicates a maximum number of allowable PRACH retransmissions.
Aspect 37: The method of any of Aspects 24-36, further comprising outputting a power boosting value indicating a number of power boosting steps for one or more PRACH retransmissions.
Aspect 38: The method of Aspect 37, wherein the power boosting value is output to the UE via downlink control information signaling.
Aspect 39: The method of Aspect 37, wherein the power boosting value is output to the UE via radio resource control signaling.
Aspect 40: The method of any of Aspects 24-39, further comprising configuring the UE to determine a PRACH retransmission power based, at least in part, on a power boosting value associated with a number of PRACH retransmission occasions.
Aspect 41: The method of Aspect 40, wherein configuring the UE to determine the PRACH retransmission power includes aggregating two or more power boosting values from previous PRACH retransmission occasions.
Aspect 42: The method of any of Aspects 24-41, further comprising configuring the UE to retransmit the PRACH transmission until a special response is received from one or more of the serving cell or the candidate cell.
Aspect 43: The method of Aspect 42, further comprising outputting the special response transmission.
Aspect 44: The method of Aspect 43, wherein the special response transmission is output to the UE via DCI signaling or MAC-CE signaling.
Aspect 45: The method of Aspect 44, further comprising configuring the UE to perform a contention-based random access PRACH transmission in response to the UE receiving the DCI signaling.
Aspect 46: The method of any of Aspects 24-45, further comprising configuring the UE to retransmit the PRACH transmission until a maximum number of PRACH retransmission occasions has occurred.
Aspect 47: An apparatus for wireless communication at a device, comprising a processor; memory coupled with the processor; and instructions stored in the memory and executable by the processor to cause the apparatus to perform the method of one or more of Aspects 1-46.
Aspect 48: A device for wireless communication, comprising a memory and one or more processors coupled to the memory, the one or more processors configured to perform the method of one or more of Aspects 1-46.
Aspect 49: An apparatus for wireless communication, comprising at least one means for performing the method of one or more of Aspects 1-46.
Aspect 50: A non-transitory computer-readable medium storing code for wireless communication, the code comprising instructions executable by a processor to perform the method of one or more of Aspects 1-46.
Aspect 51: A non-transitory computer-readable medium storing a set of instructions for wireless communication, the set of instructions comprising one or more instructions that, when executed by one or more processors of a device, cause the device to perform the method of one or more of Aspects 1-46.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to:
receive a physical downlink control channel (PDCCH) order from a serving cell;
transmit a physical random access channel (PRACH) transmission to a candidate cell; and
determine whether to retransmit the PRACH transmission when a random access response (RAR) transmission is not configured or indicated by the serving cell or the candidate cell.

2. The UE of claim 1, wherein the one or more processors, to determine whether to retransmit the PRACH transmission, are configured to determine a number of PRACH retransmissions to attempt in response to the PDCCH order.

3. The UE of claim 1, wherein the one or more processors, to determine whether to retransmit the PRACH transmission, are configured to receive radio resource control (RRC) signaling indicating whether a PRACH retransmission is permitted.

4. The UE of claim 3, wherein the one or more processors are further configured to retransmit the PRACH transmission as a result of the RRC signaling indicating that the PRACH retransmission is permitted.

5. The UE of claim 1, wherein the one or more processors, to determine whether to retransmit the PRACH transmission, are configured to receive downlink control information (DCI) signaling indicating whether a PRACH retransmission is permitted.

6. The UE of claim 5, wherein the one or more processors are further configured to retransmit the PRACH transmission based, at least in part, on a bit in the DCI signaling.

7. The UE of claim 5, wherein the one or more processors are further configured to transmit a new PRACH transmission based, at least in part, on a bit in the DCI signaling.

8. The UE of claim 5, wherein a maximum number of PRACH retransmissions is based, at least in part, on radio resource control signaling.

9. The UE of claim 5, wherein a power associated with the PRACH retransmission is based, at least in part, on radio resource control signaling.

10. The UE of claim 5, wherein a power associated with the PRACH retransmission accumulates relative to an earlier PRACH retransmission occasion.

11. The UE of claim 5, wherein the DCI signaling includes a multi-bit field indicating a number of allowable PRACH retransmissions.

12. The UE of claim 5, wherein the DCI signaling includes a multi-bit field indicating a retransmission number associated with a most recent PRACH retransmission.

13. The UE of claim 5, wherein the DCI signaling includes a multi-bit field, wherein a bit length of the multi-bit field indicates a maximum number of allowable PRACH retransmissions.

14. The UE of claim 1, wherein the one or more processors are further configured to receive a power boosting value indicating a number of power boosting steps for one or more PRACH retransmissions.

15. The UE of claim 14, wherein the power boosting value is received via downlink control information signaling.

16. The UE of claim 14, wherein the power boosting value is received via radio resource control signaling.

17. The UE of claim 1, wherein the one or more processors are further configured to determine a PRACH retransmission power based, at least in part, on a power boosting value associated with a number of PRACH retransmission occasions.

18. The UE of claim 17, wherein the one or more processors, to determine the PRACH retransmission power, are configured to aggregate two or more power boosting values from previous PRACH retransmission occasions.

19. The UE of claim 1, wherein the one or more processors are further configured to retransmit the PRACH transmission until a special response transmission is received from one or more of the serving cell or the candidate cell.

20-28. (canceled)

29. A method of wireless communication performed by a user equipment (UE), comprising:
receiving a physical downlink control channel (PDCCH) order from a serving cell;
transmitting a physical random access channel (PRACH) transmission to a candidate cell; and
determining whether to retransmit the PRACH transmission when a random access response (RAR) transmission is not configured or indicated by the serving cell or the candidate cell.

30. (canceled)
